(19) United States
(12) Patent Application Publication
(10) Pub. No.: US 2024/0214550 A1
(43) Pub. Date: Jun. 27, 2024

(54) DISPLAY DEVICE AND TEST SYSTEM COMPRISING THE SAME

(71) Applicant: SAMSUNG DISPLAY CO., LTD., YONGIN-SI (KR)

(72) Inventors: Young Min PARK, Yongin-si (KR); O Jun KWON, Yongin-si (KR); Jin SEO, Yongin-si (KR); A Ree SONG, Yongin-si (KR); Eun Jung LEE, Yongin-si (KR); Ha Young LEE, Yongin-si (KR); Young Sang HA, Yongin-si (KR)

(21) Appl. No.: 18/382,091

(22) Filed: Oct. 20, 2023

(30) Foreign Application Priority Data
Dec. 26, 2022 (KR) 10-2022-0184063

(51) Int. Cl. H04N 13/398; H04N 13/111; H04N 13/305

(52) U.S. Cl. CPC H04N 13/398; H04N 13/111; H04N 13/305

(57) ABSTRACT

A display device comprises a display panel comprising a plurality of sub-pixels. An optical member is attached to the display panel. The optical member includes stereoscopic lenses. A display driver receives a correction coefficient for each view point of the display panel from a test apparatus for the display panel. The display driver corrects image data for each view point using the correction coefficient for each view point and drives the display panel so that an image associated with the corrected image data is displayed in a display area.

This application claims priority under 35 U.S.C. 119 to Korean Patent Application No. 10-2022-0184063, filed on Dec. 26, 2022, in the Korean Intellectual Property Office, the disclosure of which is incorporated by reference in its entirety herein.

### 1. TECHNICAL FIELD

The present disclosure relates to a display device and a test apparatus including the same.

### 2. DISCUSSION OF RELATED ART

A three-dimensional (3D) image display device and a viewing-angle control display device that provide divided images of the display device in a space in front of the display device using an optical member have been developed. A 3D image display device separately displays a left-eye image and a right-eye image to so that a viewer perceives 3D images using binocular parallax.

The 3D display technology is divided into a stereoscopic technique and an auto-stereoscopic technique. The stereoscopic technique utilizes parallax images between the left and right eyes of the viewer, which provide large stereoscopic effects. The stereoscopic technique may be realized with or without glasses (e.g., glasses-free 3D).

For the stereoscopic technique with glasses, a left-eye image and a right-eye image having different polarizations are displayed so that a viewer wearing polarization glasses or shutter glasses can see 3D images. For glasses-free stereoscopic technique, an optical member such as a parallax barrier and a lenticular sheet is formed in the display device, and the optical axis of a left-eye image is separated from the optical axis of a right-eye image, so that a viewer can see 3D images. Unfortunately, a glasses-free stereoscopic display device has a problem of the overlap of images across adjacent view points.

### SUMMARY

Aspects of the present disclosure provide a display device that can detect accurately and more easily the amount of crosstalk that results in a mixed image at each view point due to imperfect separation of images for different view points or the leakage of an image for one view into another, and a test system including the same.

Aspects of the present disclosure also provide a display device that designates a correction coefficient for each view point based on the magnitude of crosstalk for each view point of the display device, and corrects image data for the respective view point with the correction coefficient to display it, and a test system including the same.

It should be noted that objects of embodiments of the present disclosure are not limited to the above-mentioned object; and other objects of embodiments of the present disclosure will be apparent to those skilled in the art from the following descriptions.

According to an embodiment of the disclosure, a display device comprises a display panel comprising a plurality of sub-pixels. An optical member is attached to the display panel. The optical member includes stereoscopic lenses. A display driver receives a correction coefficient for each view point of the display panel from a test apparatus for the display panel. The display driver corrects image data for each view point using the correction coefficient for each view point and drives the display panel so that an image associated with the corrected image data is displayed in a display area.

In an embodiment, the display driver designates a view point and a view point number to each of the plurality of sub-pixels based on relative positions of the plurality of sub-pixels for each stereoscopic lens of the stereoscopic lenses of the optical member, aligns positions of the image data in horizontal lines according to the view point and the view point number of each of the plurality of sub-pixels, and corrects the image data for each view point with the correction coefficient for each view point to display the image associated with the corrected image data in the display area.

In an embodiment, the test apparatus comprises an optical property detector detecting optical properties of a display image for each view point of the display panel and generating and outputting an optical property detection signal. A detection position adjuster moves an optical detection position of the optical property detector to a predetermined detection position for each view point of the display panel. An optical property analyzer analyzes the optical property detection signal for each view point output from the optical property detector and generates and outputs the correction coefficient for each view point according to the detected optical properties for each view point.

In an embodiment, view points and view point numbers of the display panel are in line with widths of the stereoscopic lenses in a thickness direction, respectively. Numbers of the view points and view point numbers are equal to a number of the plurality of sub-pixels disposed on a rear side of each of the stereoscopic lenses.

In an embodiment, the detection position adjuster sequentially moves the optical property detector to the predetermined detection position for each view point. The optical property detector detects one of optical properties selected from luminance, illuminance and amount of light of the display image displayed on the display panel for each view point, and transmits the optical property detection signal corresponding to the one of the optical properties selected from luminance, illuminance and amount of light to the optical property analyzer.

In an embodiment, the optical property detector comprises at least one integrating sphere. At least one optical property detection sensor is disposed inside the at least one integrating sphere.

In an embodiment, the detection position adjuster moves the optical property detector along a curved track in a circular, elliptical or semi-circular shape with respect to a center point of the display panel. A distance between the center point of the display panel and the optical property detector is maintained along the curved track.

In an embodiment, the optical property analyzer converts the optical property detection signal for each view point into a digital signal, and calculates the correction coefficient for each view point of the display panel by comparing and analyzing optical property values for different view points in the converted optical property detection signal with a predetermined calculation formula.

In an embodiment, the optical property analyzer analyzes for each view point an average or a sum of optical property values of remaining view points designated by the display driver relative to an optical property value of each view point. The optical property analyzer compares the optical property value for each view point with the average or sum of the optical property values of the remaining view points designated by the display driver and calculates the correction coefficient for each view point. The correction coefficient is calculated so that a difference value between the optical property value for each view point and the average or sum of the optical property values of the remaining view points is minimized.

According to an embodiment of the disclosure, a test system comprises a display device for displaying a stereoscopic image through a display panel having an optical member attached thereto. A test apparatus detects optical properties of a display image for each view point of the display panel. The test apparatus generates and outputs a correction coefficient for each view point according to the detected optical properties for each view point. The test apparatus generates optical property detection signals according to the detected optical properties of the display image for different view points of the display panel, and calculates the correction coefficient for each view point according to analysis results of the optical property detection signals for the view points.

In an embodiment, the display device further comprises a display driver receiving the correction coefficient for each view point of the display panel from the test apparatus. The display driver correcting image data for each view point using the correction coefficient for each view point, and driving the display panel to display an image associated with the corrected image data in a display area.

In an embodiment, the test apparatus comprises an optical property detector detecting optical properties of a display image for each view point of the display panel and generating and outputting the optical property detection signal. A detection position adjuster moving an optical detection position of the optical property detector to a predetermined detection position for each view point of the display panel. An optical property analyzer analyzing the optical property detection signal for each view point output from the optical property detector and generating and outputting the correction coefficient for each view point according to the detected optical properties for each view point.

In an embodiment, the detection position adjuster sequentially moves the optical property detector to the predetermined detection position for each view point and the optical property detector detects one of optical properties selected from luminance, illuminance and amount of light of the display image displayed on the display panel for each view point, and the transmits the optical property detection signal corresponding to the one of the optical properties selected from the luminance, illuminance and amount of light to the optical property analyzer.

In an embodiment, the detection position adjuster moves the optical property detector along a curved track in a circular, elliptical or semi-circular shape with respect to a center point of the display panel. A distance between the center point of the display panel and the optical property detector is maintained along the curved track.

In an embodiment, the optical property analyzer converts the optical property detection signal for each view point into a digital signal and calculates the correction coefficient for each view point of the display panel by comparing and analyzing optical property values for different view points in the converted optical property detection signal with a predetermined calculation formula.

In an embodiment, the optical property analyzer analyzes for each view point an average or a sum of optical property values of remaining view points relative to an optical property value of each view point. The optical property analyzer compares the optical property value for each view point with the average or sum of the optical property values of the remaining view points and calculates the correction coefficient for each view point. The correction coefficient is calculated so that a difference value between the optical property value for each view point and the average or sum of the optical property values of the remaining view points is minimized.

In an embodiment, the optical property analyzer analyzes for each view point analysis results of a sum of optical property values of remaining view points relative to an optical property value of each view point. The optical property analyzer calculates the correction coefficient for each view point in inversely proportional to the analysis results from a memory or a register so that a difference value between the optical property value for each view point and the sum of the optical property values of the remaining view points is minimized.

In an embodiment, the correction coefficient for each view point is set in inverse proportion to the difference value between the optical property value for each view point and the sum of optical property values of the remaining view points and stored in a memory or a register in advance.

In an embodiment, the optical property analyzer analyzes analysis results of an average of optical property values of remaining view points relative to an optical property value of each view point. The optical property analyzer calculates the correction coefficient for each view point in inverse proportion to the analysis results from a memory or a register. The calculation of the correction coefficient minimizes a difference value between the optical property value for each view point and the average of the optical property values of the remaining view points.

In an embodiment, the correction coefficient for each view point is set in inverse proportion to the difference value between the optical property value for each view point and the average of optical property values of the remaining view points and stored in a memory or a register in advance.

According to embodiments of the present disclosure, it is possible to accurately detect the magnitude of crosstalk at every predetermined view point with a test apparatus while it rotates in a hemispherical shape with an equal distance to a display device, thereby increasing the efficiency of detecting the amount of crosstalk. Alternatively, it is possible to detect the magnitude of crosstalk for every predetermined view point by rotating the display device while maintaining the distance between the test apparatus and the center axis of the display device.

In addition, according to embodiments of the present disclosure, the display quality of 3D images of the display device can be increased by correcting image data at each view point based on the magnitude of crosstalk at that view point.

It should be noted that effects of embodiments of the present disclosure are not limited to those described above and other effects of the present disclosure will be apparent to those skilled in the art from the following descriptions.

### BRIEF DESCRIPTION OF THE DRAWINGS

The above and other aspects and features of embodiments of the present disclosure will become more apparent by describing in detail embodiments thereof with reference to the attached drawings, in which:

FIG. 1 is an exploded, perspective view showing a display device according to an embodiment of the present disclosure.

FIG. 2 is a perspective view showing the display panel and the optical member shown in FIG. 1 when they are attached together.

FIG. 3 is a block diagram illustrating a test system including a display device and a test apparatus according to an embodiment.

FIG. 4 is a plan view showing a portion of the arrangement structure of the sub-pixels of the display area.

FIG. 5 is a plan view showing a portion of an arrangement structure of sub-pixels of a display area according to an embodiment.

FIG. 6 is a view showing a method of setting view point information for each sub-pixel according to the lens width of an optical member.

FIG. 7 is a view showing in detail a method of designating view point information to each sub-pixel according to the lens width and the curvature.

FIG. 8 is a perspective view showing an arrangement structure of a display device and a test apparatus according to an embodiment.

FIG. 9 is a side view showing a cross-sectional structure of the optical property detector shown in FIG. 8 and a process of detecting optical properties.

FIG. 10 is a view showing an order in which sub-pixels for different view points of the display device shown in FIG. 8 emit lights.

FIG. 11 is a view showing a method of detecting the amount of crosstalk for each view point of a display device.

FIG. 12 is a table showing results of detecting luminance values for different view points according to an embodiment.

FIG. 13 is a table showing results of detecting luminance values for different view points according to an embodiment.

FIG. 14 is a side view showing a method of detecting the amount of crosstalk for each view point of a display device according to another embodiment.

FIG. 15 is an exploded, perspective view of a display device according to an embodiment of the present disclosure.

FIG. 16 is a plan view showing the display panel and the optical member shown in FIG. 15.

FIG. 17 is a perspective view showing an instrument cluster and a center fascia including display devices according to an embodiment.

FIG. 18 is a perspective view showing an example of a watch-type smart device including a display device according to an embodiment of the present disclosure.

FIG. 19 is a perspective view showing a glasses-type virtual reality device including a display device according to an embodiment.

FIG. 20 is a perspective view showing a transparent display apparatus including a transparent display device according to an embodiment.

### DETAILED DESCRIPTION OF EMBODIMENTS

The present disclosure will now be described more fully hereinafter with reference to the accompanying drawings, in which embodiments of the disclosure are shown. This disclosure may, however, be embodied in different forms and should not be construed as limited to the described embodiments set forth herein.

It will also be understood that when a layer is referred to as being “on” another layer or substrate, it can be directly on the other layer or substrate, or intervening layers may also be present. When a layer is referred to as being “directly on” another layer or substrate, no intervening layers may be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

Each of the features of the various embodiments of the present disclosure may be combined or combined with each other, in part or in whole, and technically various interlocking and driving are possible. Each embodiment may be implemented independently of each other or may be implemented together in an association.

Hereinafter, embodiments of the present disclosure will be described with reference to the accompanying drawings.

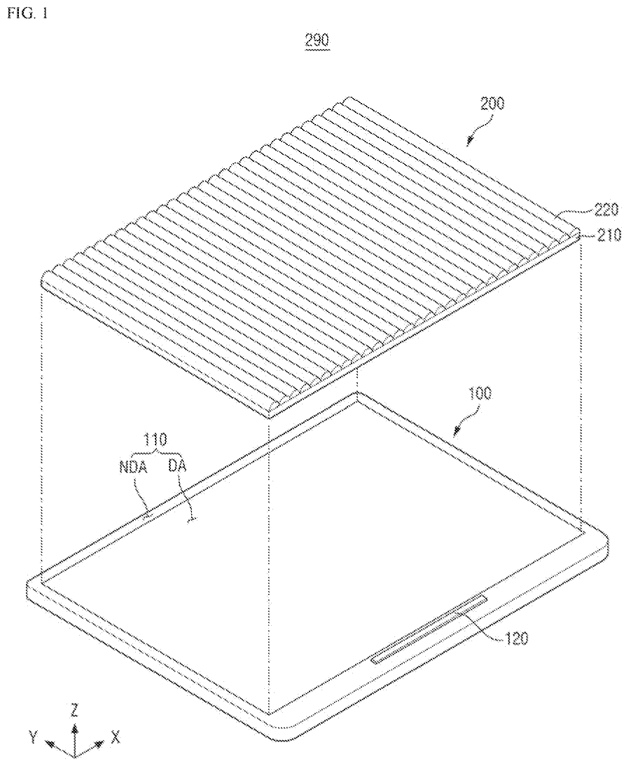

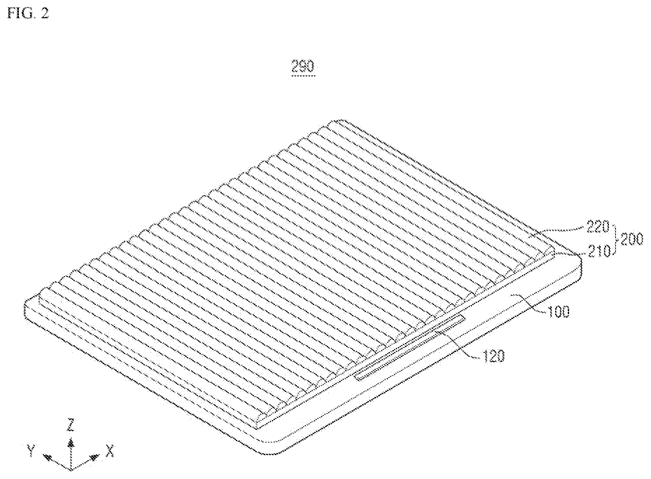

FIG. 1 is an exploded, perspective view showing a display device according to an embodiment of the present disclosure. FIG. 2 is a view showing the display panel and the optical member shown in FIG. 1 when they are attached together.

Referring to FIGS. 1 and 2, in an embodiment a display device 290 may be implemented as a flat panel display device such as a liquid-crystal display (LCD) device, a field emission display (FED) device, a plasma display panel (PDP) device, and an organic light-emitting display (OLED) device. However, embodiments of the present disclosure are not necessarily limited thereto.

The display device 290 may be a 3D image display device including a display module 100 and an optical member 200. The 3D image display device separately displays a left-eye image and a right-eye image on the front side to permit a viewer to visualize 3D images utilizing binocular parallax. Furthermore, the 3D image display device may separately provide images at different viewing angles on the front side of the display device so that different images are displayed at the different viewing angles.

The 3D image display device may be a light-field display device that allows different image information to be seen by a viewers' eyes, respectively, by disposing the optical member 200 on the front side of the display module 100. The light-field display device may generate a 3D image by generating a light field with the display module 100 and the 3D optical member 200. As will be described later, light rays generated in each of the pixels of the display module 100 of the light-field display device form a light field directed in a particular direction (e.g., a particular viewing angle and/or a particular viewpoint) by stereoscopic lenses, pinholes or barriers. In this manner, 3D image information associated with the particular direction can be provided to the viewer.

In an embodiment, the display module 100 may include a display panel 110, a display driver 120, and a circuit board.

The display panel 110 may include a display area DA and a non-display area NDA. The display area DA may include data lines, scan lines, supply voltage lines, and a plurality of pixels connected to the data lines and scan lines. For example, in an embodiment the scan lines may extend in the first direction (e.g., an x-axis direction) and be spaced apart from one another in the second direction (e.g., a y-axis direction). The data lines and the supply voltage lines may extend in the second direction (e.g., the y-axis direction) and be spaced apart from one another in the first direction (e.g., the x-axis direction).

Each of the pixels may be connected to at least one scan line, data line, and supply voltage line. Each of the pixels may include thin-film transistors including a driving transistor and at least one switching transistor, a light-emitting element, and a capacitor. When a scan signal is applied from a scan line, each of the pixels receives a data voltage from a data line and supplies a driving current to the light-emitting element according to the data voltage applied to the gate electrode, so that light can be emitted.

In an embodiment, the non-display area NDA may be disposed at the edge of the display panel 110 to at least partially surround the display area DA (e.g., in the x-axis and/or y-axis directions). For example, the non-display area NDA may include a scan driver that applies scan signals to scan lines, and pads connected to the display driver 120. For example, the display driver 120 may be disposed on one side of the non-display area NDA, and the pads may be disposed on one edge of the non-display area NDA on which the display driver 120 is disposed.

The display driver 120 may output signals and voltages for driving the display panel 110. The display driver 120 may supply data voltages to data lines. The display driver 120 supplies supply voltage to the supply voltage line, and may supply scan control signals to the scan driver. For example, in an embodiment the display driver 120 may be implemented as an integrated circuit (IC) and may be disposed in the non-display area NDA of the display panel 110 by a chip on glass (COG) technique, a chip on plastic (COP) technique, or an ultrasonic bonding. However, embodiments of the present disclosure are not necessarily limited thereto. For another example, the display driver 120 may be mounted on a circuit board and connected to the pads of the display panel 110.

The display driver 120 receives and stores a correction coefficient for each view point from a test apparatus. The display driver 120 designates the view point and the view point number to each of the sub-pixels based on the relative positions of the sub-pixels for each of the stereoscopic lenses 220. In addition, the display driver 120 aligns positions of image data input from an external source for each horizontal line based on the view point and the view point number of each of the sub-pixels. Subsequently, the display driver 120 corrects the image data for each view point using the correction coefficient for each view point received from the test apparatus and generates corrected image data. The display driver 120 may generate data voltages corresponding to the corrected image data and supply them to the data lines, so that images can be displayed based on the relative positions of the sub-pixels with respect to the stereoscopic lenses 220.

The optical member 200 may be disposed on the front side of the display module 100. In an embodiment, the optical member 200 may be attached to one surface of the display module 100 (e.g., a front surface, such as an upper surface in the z-axis direction) through an adhesive member. The optical member 200 may be attached to the front surface of the display module 100 by a panel bonding apparatus. For example, the optical member 200 may be implemented as a lenticular lens sheet including the stereoscopic lenses 220. For another example, the stereoscopic lenses 220 may be implemented as liquid-crystal lenses that work as lenses by controlling liquid crystals in liquid-crystal layers. In an embodiment in which the stereoscopic lenses 220 are implemented as the lenticular lens sheet, the stereoscopic lenses 220 may be disposed on the flat portion 210.

The flat portion 210 may be disposed directly on the front side of the display module 100. For example, a first surface of the flat portion 210 facing the display module 100 and an opposite second surface of the flat portion 210 opposed to the one surface of the flat portion 210 may be parallel to each other. The flat portion 210 may output the light incident from the display module 100 as it is. The direction of light passing through the surface of the flat portion 210 may be coincident with the direction of light passing through the opposite surface of the flat portion 210. In an embodiment, the flat portion 210 may be formed integrally with the stereoscopic lenses 220. However, embodiments of the present disclosure are not necessarily limited thereto.

The stereoscopic lenses 220 may be disposed on the flat portion 210 to change the directions in which lights incident from the display module 100 on the rear side exit or travel toward the front side. For example, the image display lights incident from the rear side of the display module 100 may pass through the flat portion 210 to reach the rear side of the stereoscopic lenses 220.

The stereoscopic lenses 220 may be inclined at a predetermined angle from one side of the display module 100. For example, the stereoscopic lenses 220 may be slanted lenses inclined by a predetermined angle from the side of each of the plurality of pixels of the display panel 110 or half-cylindrical Lenses. The predetermined angle may be designed to prevent the color lines of the display device from being perceived by a viewer. For another example, the stereoscopic lenses 220 may be implemented as Fresnel Lenses. However the shape or type of the stereoscopic lenses 220 is not necessarily limited thereto.

The stereoscopic lenses 220 may be fabricated separately from the flat portion 210 and then may be attached to the flat portion 210. Alternatively, the stereoscopic lenses 220 may be formed integrally with the flat portion 210. For example, the stereoscopic lenses 220 may be embossed into the upper surface of the flat portion 210. However, embodiments of the present disclosure are not necessarily limited thereto.

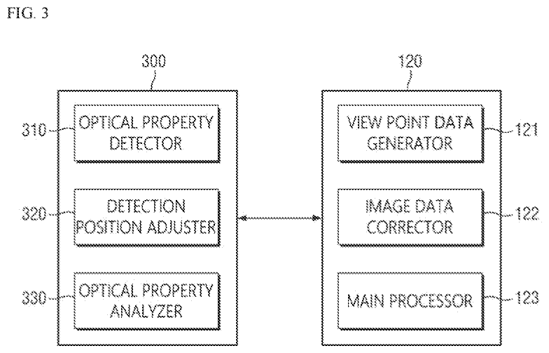

FIG. 3 is a block diagram illustrating a test system including a display device and a test apparatus according to an embodiment.

Referring to FIG. 3, a test apparatus 300 includes an optical property detector 310, a detection position adjuster 320, and an optical property analyzer 330.

The optical property detector 310 detects the optical properties of the display image for each view point and generates an optical property detection signal that is output. In an embodiment, the optical property detector 310 detects the optical properties of one of luminance, illuminance and amount of light of the display image displayed for each view point in the display device 290 to generate and output an optical property detection signal corresponding to a change in the optical properties.

For example, the optical property detector 310 is assembled or mounted to the detection position adjuster 320 and moves to a detection position for each view point by the driving of the detection position adjuster 320. Accordingly, the optical property detector 310 is moved to the detection position for each view point, and detects one of the optical properties including the luminance, the illuminance and the amount of light of the display image displayed for each view point on the display device 290. The optical property detector 310 then transmits an optical property detection signal associated with one of the optical properties including the luminance, the illuminance and the amount of light to the optical property analyzer 330.

The view points of the display device 290 may be set depending on the relative positions of the sub-pixels with respect to each of the stereoscopic lenses 220.

For example, the view points of the display device 290 may be in line with, or lie within, the width of each stereoscopic lenses 220 in the thickness direction, and thus the number of the view points may be equal to the number of the sub-pixels disposed on the rear side of each of the stereoscopic lenses 220. For example, if the number of the sub-pixels disposed on the rear surface of each of the stereoscopic lenses 220 in line with or lie within the width of its rear surface (e.g., a base surface or a base side) is 24, there may be 24 view points for detecting optical properties of the display device 290. Alternatively, if the number of the sub-pixels disposed on the rear surface of each of the stereoscopic lenses 220 in line with or lie within the width of its rear surface is 12, there may be 12 view points for detecting optical properties of the display device 290.

The detection position adjuster 320 moves the light detection position of the optical property detector 310 to a predetermined detection position for each view point. For example, in an embodiment in which the number of view points of the display device 290 is set to 24, the detection position adjuster 320 may move the optical property detector 310 to the detection positions for the 24 view points.

The detection position adjuster 320 sequentially moves the optical property detector 310 to the detection positions for different view points so that the interval or distance between the center point of the display device 290 and the detection positions for the view points is equally maintained.

For example, the detection position adjuster 320 may move the optical property detector 310 along a curved track with respect to the center point of the display device 290 so that the distance between the center point of the display device 290 and the optical property detector 310 can be equally maintained. In doing so, the detection position adjuster 320 may move the optical property detector 310 in a curved track such as a circle, an ellipse and a semi-circle. However, embodiments of the present disclosure are not necessarily limited thereto.

In addition, the detection position adjuster 320 may move the optical property detector 310 along a circular track so that the detection position adjuster 320 is rotated in a horizontal direction (e.g., x-axis direction) with respect to the display device 290 and the center point of the display device 290.

The detection position adjuster 320 may move the optical property detector 310 along a curved track, and may temporarily stop the movement of the optical property detector 310 at the detection position for each view point so that the optical property detector 310 detects the optical properties of the display image for each view point.

The optical property analyzer 330 analyzes the optical property detection signal for each view point output from the optical property detector 310 to generate and output a correction coefficient for each view point based on the optical properties for each view point.

For example, in an embodiment the optical property analyzer 330 digitally converts the optical property detection signal for each view point. The optical property analyzer 330 then compares and analyzes optical property values for different view points to calculate a correction coefficient for each of the view points for the display device 290. For example, in an embodiment the optical property analyzer 330 analyzes the average or the sum of optical property values of the rest of the view points relative to the optical property value for each view point. In addition, the optical property analyzer 330 compares the optical property value for each view point with the average or the sum of optical property values of the remaining view points. The optical property analyzer 330 may extract or calculate a correction coefficient for each view point to minimize a difference value between the optical property value for each view point and the average or the sum of optical property values of the remaining view points. In this instance, the correction coefficient for each view point may be set in an inverse proportion to the difference value between the optical property value for each view point and the average or the sum of the remaining the view points. The correction coefficient for each view point may be set in advance based on a number of experimental results and calculation results in a database.

Referring to FIG. 3, the display driver 120 of the display device 290 includes a view point data generator 121, an image data corrector 122, and a main processor 123.

In an embodiment, the view point data generator 121 of the display driver 120 aligns image data input from an external source according to the positions of the sub-pixels in the vertical and horizontal directions, and designates view point numbers to the aligned sub-pixels based on the predetermined width information of lenses and the size information for each sub-pixel.

The image data corrector 122 corrects the image data for each view point by calculating the correction coefficient for each view point received from the optical property analyzer 330 of the test device 300. In an embodiment, the display driver 120 may generate corrected image data for each view point by adding/subtracting the correction coefficient for each view point to/from the image data for each view point or multiplying the image data for each view point by the correction coefficient.

The main processor 123 generates data voltages corresponding to grayscale values or luminance values of the corrected image data for different view points. In addition, by supplying data voltages to the data lines of the display panel 110, images are displayed depending on the relative positions of the sub-pixels with respect to the stereoscopic lenses 220.

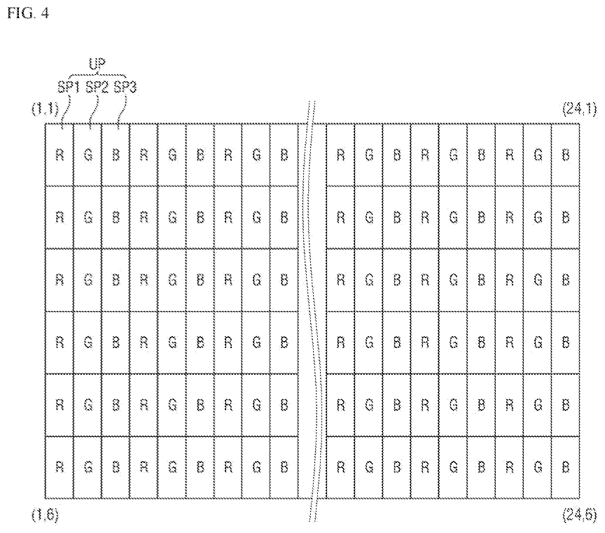

FIG. 4 is a plan view showing a portion of the arrangement structure of the sub-pixels of the display area.

FIG. 4 shows the arrangement structure of sub-pixels arranged in six rows and twenty-four columns. Accordingly, the arrangement structure includes the sub-pixel located at the first row and the first column to the sub-pixel located at the sixth row and the twenty-fourth column.

Referring to FIG. 4, a plurality of unit pixels UP is disposed and formed in the display area DA of the display panel 110, and each of the unit pixels UP includes a plurality of sub-pixels, such as first to third sub-pixels SP1, SP2 and SP3. However, embodiments of the present disclosure are not necessarily limited thereto and the number of sub-pixels may vary. In an embodiment, the first to third sub-pixels SP1, SP2 and SP3 may be arranged along a plurality of rows and a plurality of columns. For example, the first to third sub-pixels SP1, SP2 and SP3 may be arranged and formed in a vertical or horizontal stripe structure. The display area DA of the display panel 110 may include more unit pixels UP as the resolution of the display device increases.

More specifically, each of the unit pixels UP may include first to third sub-pixels SP1 SP2 and SP3 displaying different colors from each other. The first to third sub-pixels SP1 SP2 and SP3 may be formed as n data lines and m scan lines intersect each other, in which n and m are each natural numbers. Each of the plurality of sub-pixels, such as the first to third sub-pixels SP1 SP2 and SP3, may include a light-emitting element and a pixel circuit. The pixel circuit may include a driving transistor, at least one switching transistor and at least one capacitor to drive the light-emitting element of each of the plurality of sub-pixels.

In an embodiment, each of the plurality of unit pixels UP may include one first sub-pixel SP1, one second sub-pixel SP2, and one third sub-pixel SP3. Alternatively, each of the plurality of unit pixels UP may include four sub-pixels, such as one first sub-pixel SP1, two second sub-pixels SP2, and one third sub-pixel SP3. However, the number of sub-pixels included in each unit pixel UP and the arrangement of such sub-pixels are not necessarily limited thereto. The first sub-pixel SP1 may be a red sub-pixel, the second sub-pixel SP2 may be a green sub-pixel, and the third sub-pixel SP3 may be a blue sub-pixel. Each of the first to third sub-pixels SP1 SP2 and SP3 may receive a data signal containing luminance information of red, green or blue light from the display driver 120 and may output light of the respective color.

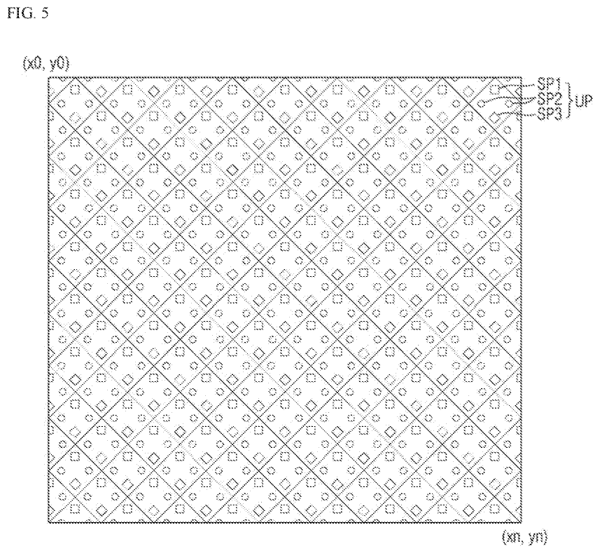

FIG. 5 is a plan view showing a portion of an arrangement structure of sub-pixels of a display area according to an embodiment.

Referring to FIG. 5, a plurality of unit pixels UP and a plurality of sub-pixels, such as first to third sub-pixels SP1, SP2 and SP3 may be arranged in the Pentile™ matrix. For example, each of the plurality of unit pixels UP may include first to third sub-pixels SP1, SP2 and SP3 arranged in the Pentile™ matrix. The first to third sub-pixels SP1, SP2 and SP3 may be formed as n data lines and m scan lines that intersect each other, in which n and m are natural numbers.

Each of the plurality of unit pixels UP may include, but is not necessarily limited to, one first sub-pixel SP1, two second sub-pixels SP2, and one third sub-pixel SP3. In an embodiment, the first sub-pixel SP1 may be a red sub-pixel, the second sub-pixel SP2 may be a green sub-pixel, and the third sub-pixel SP3 may be a blue sub-pixel. The size of the opening of each of the first to third sub-pixels SP1, SP2 and SP3 may be determined depending on the luminance of the light. Accordingly, the size of the opening of each of the first to third sub-pixels SP1, SP2 and SP3 may be adjusted to represent white light by mixing lights emitted from a plurality of emissive layers. Each of the first to third sub-pixels SP1 SP2 and SP3 may receive a data signal containing luminance information of red, green or blue light from the display driver 120 and may output light of the respective color.

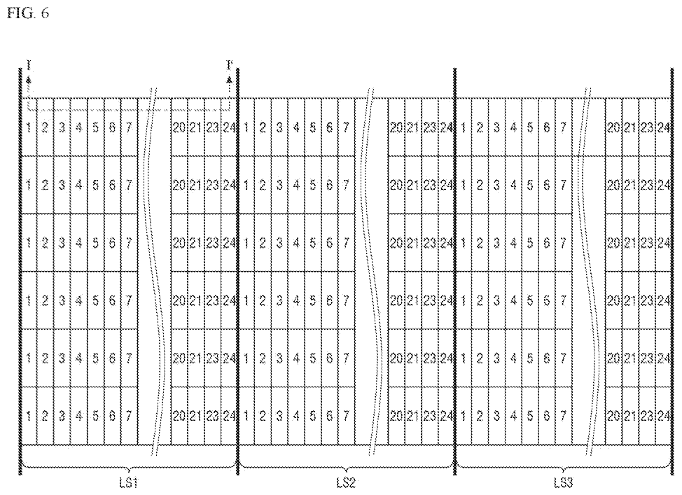

FIG. 6 is a view showing a method of setting view point information for each sub-pixel according to the lens width of an optical member.

Referring to FIG. 6, the view point information and view point numbers for each sub-pixel are designated in the order of the relative positions of the first to third sub-pixels SP1, SP2 and SP3 overlapping the stereoscopic lens, such as first to third stereoscopic lenses LS1, LS2 and LS3, based on the information on the width and the slanted angle of each of the first to third stereoscopic lenses LS1, LS2 and LS3, etc.

For example, the view point information and view point number according to the relative positions of the first to third sub-pixels SP1, SP2 and SP3 overlapping the first to third stereoscopic lenses LS1, LS2 and LS3, respectively, may be designated repeatedly in the width direction of the stereoscopic lenses LS1, LS2 and LS3 or in the x-axis direction. This may be expressed in Equation 1 below:

$$\\ \begin{matrix}view point information ( or view point number ) = rows \times pixel size \times tan ( slanted angle ) & [ Equation 1 ]\end{matrix}$$

wherein rows denote the number in the horizontal line direction, and pixel size denotes the width or size of each sub-pixel. In addition, tan (slanted angle) denotes the slant angle tθ. According to this embodiment, the lenses are arranged side by side in the y-axis direction (e.g., a vertical direction in a plan view), and thus tan (e.g., slanted angle) is equal to 1.

The view point information (e.g., view point numbers) of the sub-pixels arranged in the first horizontal line and the view point information from the second horizontal line to the last horizontal line are the same in the y-axis direction (e.g., vertical direction in a plan view).

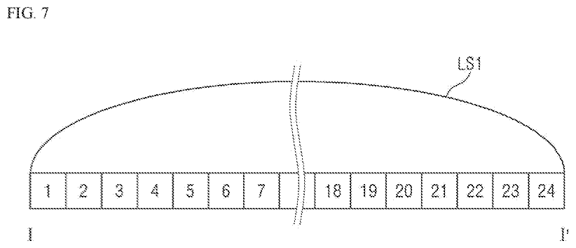

FIG. 7 is a view showing in detail a method of designating view point information to each sub-pixel according to the lens width and the curvature.

As shown in FIG. 7, view point information for each of the first to third sub-pixels SP1, SP2 and SP3 is set based on the relative positions of the first to third sub-pixels SP1, SP2 and SP3 of each of the first to third stereoscopic lenses LS1, LS2 and LS3, and image display points or view points of the display device 290 are set based on the view point information and number of each of the first to third sub-pixels SP1, SP2 and SP3.

Accordingly, the image display points or view points of the display device 290 may be in line with, or lie within, the width of each of the first to third stereoscopic lenses LS1, LS2 and LS3, and may be set in the same manner as the number and the view point numbers of the sub-pixels disposed on the rear surface of each of the first to third stereoscopic lenses LS1, LS2 and LS3.

As shown in FIG. 7, the view points may be in line with, or lie within, the width of the rear surface (e.g., base surface or base side) of each of the first to third stereoscopic lenses LS1, LS2 and LS3. For example, in an embodiment in which the number of the sub-pixels disposed on the rear surface of each of the first to third stereoscopic lenses LS1, LS2 and LS3 is 24, there may be 24 view points for detecting optical properties of the display device 290.

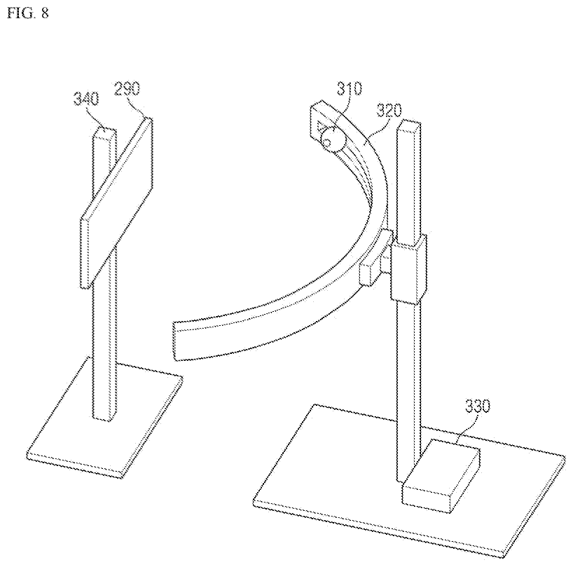

FIG. 8 is a perspective view showing an arrangement structure of a display device and a test apparatus according to an embodiment.

Referring to FIG. 8, the optical property detector 310 of the test device 300 is mounted on one side of the detection position adjuster 320 and detects the optical properties of the display image for each view point of the display device 290.

For example, in an embodiment the optical property detector 310 is assembled or mounted on the detection position adjuster 320 and the detection position adjuster 320 moves the optical property detector 310 to a detection position for each view point by the driving of the detection position adjuster 320. Accordingly, the optical property detector 310 is moved to the detection position for each view point, and detects luminance characteristics of the optical properties of the display image displayed for each view point on the display device 290. In addition, the optical property detector 310 generates a luminance detection signal corresponding to a change in the luminance characteristics to transmit it to the optical property analyzer 330.

In an embodiment, the detection position adjuster 320 may include a track-type transfer bar that moves the optical property detector 310 along at least one of circular, semi-circular and elliptical tracks, a support bar that supports the track-type transfer bar and moves it vertically and horizontally, and a back plate 340 that moves and supports the display device 290 in at least one of the forward, backward, left and right directions. While the optical property analyzer 330 in FIG. 8 is shown on a surface of a base holding the support bar, embodiments of the present disclosure are not necessarily limited thereto and the optical property analyzer 330 may be positioned in various different orientations.

The detection position adjuster 320 moves the optical property detector 310 to the predetermined detection position for each view point one after another along the shape of the track of the track-type transfer bar. For example, in an embodiment in which the number of view points of the display device 290 is set to 24, the detection position adjuster 320 moves the optical property detector 310 to the detection positions of each of the 24 view points.

In an embodiment, the detection position adjuster 320 sequentially moves the optical property detector 310 to the detection positions of different view points along the shape of track of the track-type transfer bar so that the interval or distance between the center point of the display device 290 and the detection positions for the view points is equally maintained.

Along the shape of the track-type transfer bar, the detection position adjuster 320 moves the optical property detector 310 along a curved track with respect to the center point of the display device 290 so that the distance between the central point of the display device 290 and the optical property detector 310 is equally maintained.

For example, in an embodiment along the shape of the track-type transfer bar, the detection position adjuster 320 moves the optical property detector 310 along a circular track so that the detection position adjuster 320 is rotated in a horizontal direction (e.g., x-axis direction) with respect to the display device 290 and the center point of the display device 290.

The detection position adjuster 320 may move the optical properties detector 310 along a circular track, and may temporarily stop the movement of the optical property detector 310 at the detection position for each view point so that the optical properties detector 310 detects the optical properties of the display image for each view point.

The optical property analyzer 330 converts the optical property detection signal for each view point output from the optical property detector 310 into a digital signal, and calculates a correction coefficient for each view point of the display device 290 by comparing and analyzing the optical property values for different view points.

For example, in an embodiment the optical property analyzer 330 analyzes a difference value of the average of optical property values of the remaining view points relative to the optical property value for each view point. The optical property analyzer 330 may then calculate a correction coefficient for each view point to minimize the difference value between the optical property value for each view point and the average of optical property values of the remaining view points. In an embodiment, the correction coefficient for each view point may be set in an inverse proportion to the difference value between the optical property value for each view point and the average of the remaining view points. In addition, the correction coefficient for each view point may be set in advance based on a number of experimental results and calculation results in a database.

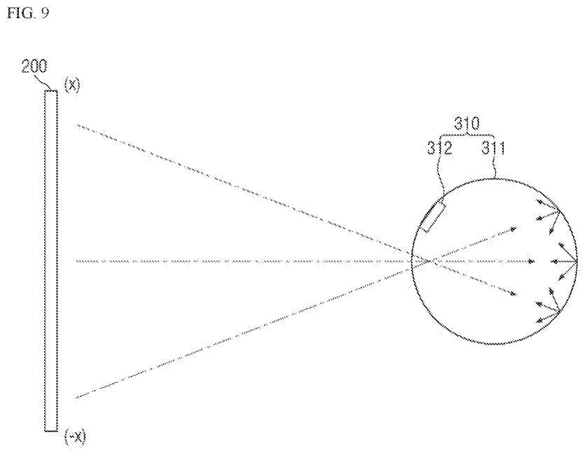

FIG. 9 is a view showing a cross-sectional structure of the optical property detector shown in FIG. 8 and a process of detecting optical properties.

Referring to FIG. 9, the optical property detector 310 may include at least one integrating sphere 311, and at least one optical property detection sensor 312 disposed inside the at least one integrating sphere 311.

The optical properties, for example, the luminance characteristics inside the integrating sphere 311 are constant at any angle. Therefore, the integrating sphere 311 captures the image display light for each view point output from the display device 290 and distributes it evenly on the inner surface of the integrating sphere 311.

The optical property detection sensor 312 disposed inside the integrating sphere 311 generates and outputs an optical property detection signal in response to a change in optical properties distributed inside the integrating sphere 311.

In an embodiment, the optical property detection sensor 312 may generate one optical property detection signal according to luminance, illuminance, or an amount of light. For example, the optical property detection sensor 312 may generate a luminance detection signal to transmit it to the optical property analyzer 330.

As described above, the optical property detector 310 may moved along a semi-circular or an elliptical track so that the distance from the center point of the display device 290 can be equally maintained as the detection position adjuster 320 is driven. At this time, the optical property detector 310 may rotate and move in a horizontal direction (e.g., from the -x-axis direction to the x-axis direction) with respect to the center point of the display device 290.

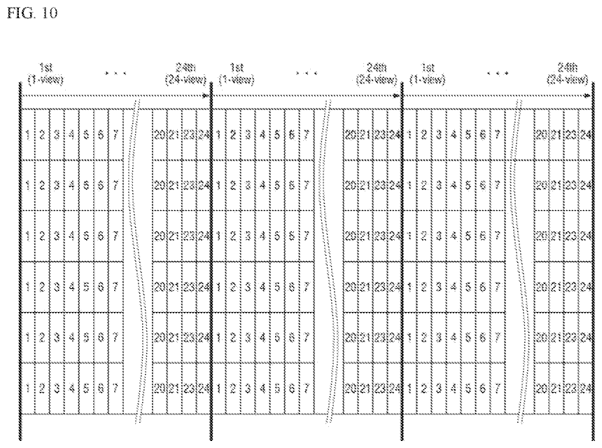

FIG. 10 is a view showing an order in which sub-pixels for different view points of the display device shown in FIG. 8 emit lights.

Referring to FIG. 10, the display driver 120 of the display device 290 supplies image voltages to the sub-pixels so that an image is displayed on the sub-pixels having the same view point number as each view point during an optical property detection period for each view point.

For example, at the timing 1st when the optical property detector 310 moves to the first view point 1-view and the optical property detector 310 detects the luminance characteristic of the first view point 1-view, the display driver 120 drives so that an image is displayed on the sub-pixels to which the first view point information (e.g., the first view point number) is designated among all of the sub-pixels of the display area DA.

Subsequently, at the timing when the optical property detector 310 detects the luminance characteristics at the second view point, the display driver 120 drives the sub-pixels of the second view point number so that an image is displayed on the sub-pixels to which the second view point information (e.g., the second view point number) is designated among all of the sub-pixels in the display area DA.

Subsequently, at the timing when the optical property detector 310 detects the luminance characteristics at the third view point, the display driver 120 drives the sub-pixels of the third view point number so that an image is displayed on the sub-pixels to which the third view point information (e.g., the third view point number) is designated among all of the sub-pixels in the display area DA.

In this manner, in an embodiment the display driver 120 sequentially drives the sub-pixels for different view points such that the sub-pixels of the view point numbers sequentially display images every timing (e.g., 1st to 24th) at which luminance characteristics are sequentially detected by the optical property detector 310 moving from the position of the first view point to the position of the last twenty-fourth view point 24-view.

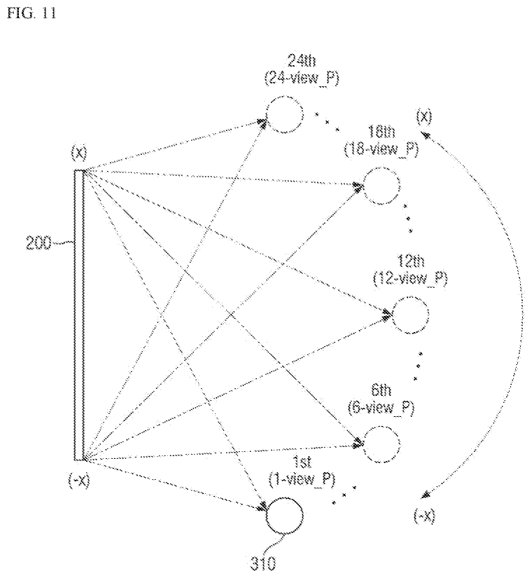

FIG. 11 is a view showing a method of detecting the amount of crosstalk for each view point of a display device.

Referring to FIG. 11, firstly, at the timing of detecting the luminance characteristics at the first view point, the optical property detector 310 is moved to and located at the detection position 1-view_P of the first view point by the detection position adjuster 320.

At the timing when the optical property detector 310 detects the luminance characteristics at the first view point, the display driver 120 drives the sub-pixels of the first view point information (e.g., the first view point number) among all the sub-pixels to display an image with the sub-pixels of the first view point number.

The optical property detector 310 detects the optical properties, for example, the luminance characteristics of the display image at the detection position 1-view_P of the first view point, and generates a luminance detection signal corresponding to a change in the luminance characteristic to transmit it to the optical property analyzer 330.

Subsequently, at the timing of detecting the luminance characteristics at the second view point, the optical property detector 310 is moved to and located at the detection position of the second view point by the detection position adjuster 320.

At the timing when the optical property detector 310 detects the luminance characteristics at the second view point, the display driver 120 drives the sub-pixels of the second view point information (e.g., the second view point number) among all the sub-pixels to display an image with the sub-pixels of the second view point number.

The optical property detector 310 may detect the optical properties, for example, the luminance characteristics of the display image at the detection position of the second view point, and generates a luminance detection signal corresponding to a change in the luminance characteristic to transmit it to the optical property analyzer 330.

In this manner, after luminance detection signals are detected from the detection position of the third view point to the detection position of the fifth view point, at the timing of detecting the luminance characteristics at the sixth view point, the optical property detector 310 is moved to and located at the detection position 6-view_P of the sixth view point by the detection position adjuster 320.

At the timing when the optical property detector 310 detects the luminance characteristics at the sixth view point, the display driver 120 drives the sub-pixels of the sixth view point information (e.g., the sixth view point number) among all the sub-pixels to display an image with the sub-pixels of the sixth view point number.

The optical property detector 310 may detect the luminance characteristics of the display image at the detection position 6-view_P of the sixth view point, and generates a luminance detection signal corresponding to a change in the luminance characteristic to transmit it to the optical property analyzer 330.

In this manner, after luminance detection signals are detected from the detection position of the seventh view point to the detection position of the twenty-third view point, at the timing of detecting the luminance characteristics at the last twenty-fourth view point, the optical property detector 310 is moved to and located at the detection position 24-view_P of the twenty-fourth view point by the detection position adjuster 320.

At the timing when the optical property detector 310 detects the luminance characteristics at the twenty-fourth view point, the display driver 120 drives the sub-pixels of the twenty-fourth view point information (e.g., the twenty-fourth view point number) among all the sub-pixels to display an image with the sub-pixels of the twenty-fourth point number.

The optical property detector 310 may then detect the luminance characteristics of the display image at the detection position 24-view_P of the twenty-fourth view point, and generates a luminance detection signal corresponding to a change in the luminance characteristic to transmit it to the optical property analyzer 330.

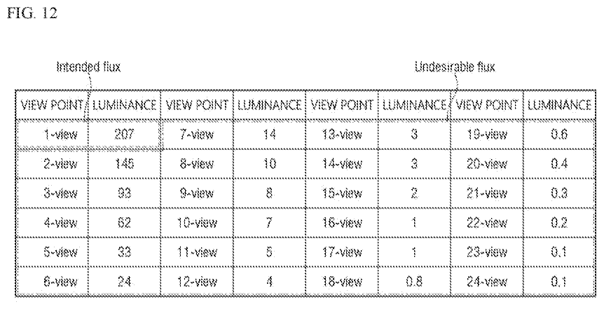

FIG. 12 is a table showing results of detecting luminance values for different view points according to an embodiment.

Referring to FIG. 12, the optical property analyzer 330 converts the optical property detection signal for each view point output from the optical property detector 310 into a digital signal, and calculates a correction coefficient for each view point of the display device 290 by comparing and analyzing the optical property values for different view points. In doing so, the optical property analyzer 330 compares the luminance characteristics value of each view point (e.g., an intended flux) with the luminance characteristics values of the remaining view points (e.g., undesirable flux) to analyze them.

$$\\ \begin{matrix}CT ( n - view ) = \frac{Sum Undisirable flux}{Intended flux} & [ Equation 2 ]\end{matrix}$$

For example, by using Equation 1, the optical property analyzer 330 compares and analyzes the analysis result values CT (n-view), e.g., a ratio of the sum of the luminance characteristics values of the remaining view points (Sum Undesirable flux) relative to the luminance characteristics value of each view point (Intended flux). In addition, in an embodiment the optical property analyzer 330 may extract from a memory or a register a correction coefficient that is inversely proportional to the analysis result value CT (n-view) so that a difference between the luminance characteristics value for each view point (Intended flux) and the sum of luminance characteristics values of the remaining view points (Sum Undesirable flux) is minimized.

In an embodiment,, the correction coefficient for each view point is set in inverse proportion to the difference value between the luminance characteristics value for each view point (Intended flux) and the sum of luminance characteristics values of the remaining view points (Sum Undesirable flux) and may be stored in a memory or a register in advance. In addition, the correction coefficient for each view point may be set in advance based on a number of experimental results and calculation results in a database.

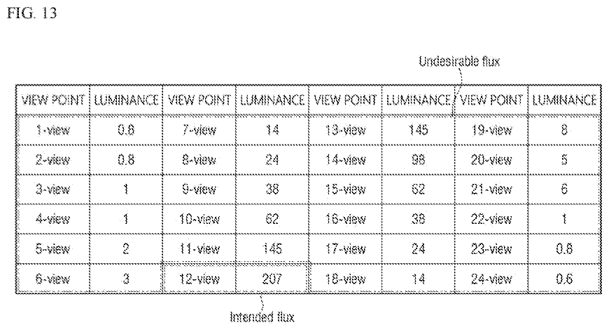

FIG. 13 is a table showing results of detecting luminance values for different view points according to an embodiment.

Referring to FIG. 13, the optical property analyzer 330 compares the luminance characteristics value of each view point (e.g., intended flux) with the luminance characteristic values of the remaining view points (e.g., undesirable flux) to analyze them.

For example, the optical property analyzer 330 compares and analyzes difference values of the luminance characteristics value of each view point (e.g., intended flux) relative to the luminance characteristic values of the remaining view points. The optical property analyzer 330 may then extract from a memory or a register a correction coefficient for each view point to minimize the difference values between the luminance characteristics value for each view point and the average of luminance characteristics values of the remaining view points.

Also in this instance, the correction coefficient for each view point is set in inverse proportion to the difference value between the luminance characteristics value for each view point (e.g., Intended flux) and the sum of luminance characteristics values of the remaining view points and may be stored in a memory or a register in advance.

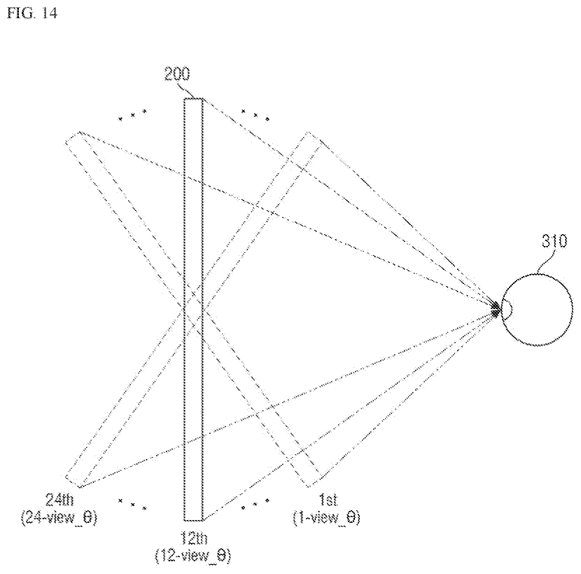

FIG. 14 is a view showing a method of detecting the amount of crosstalk for each view point of a display device according to an embodiment.

According to an embodiment of FIG. 14, unlike an embodiment in which the optical property detector 310 is moved by the detection position adjuster 320, the display device 290 is moved by rotating a back plate 340 such that the distance between the optical property detector 310 and the center axis of the display device 290 is maintained, so that it is possible to extract optical property values such as illuminance, luminance and amount of light for each predetermined view point.

For example, in an embodiment the display device 290 may be rotated by the back plate 340 at an angle associated with the detection position 1-view_P of the first view point, and then may sequentially rotated until it reaches the angle associated with the detection position 24-view_P of the twenty-fourth view point.

The optical property detector 310 detects an optical property detection signal from the display device 290 rotated by the angle associated with the detection position 1-view_P of the first view point firstly, and sequentially detects optical property signals to the 24-view_P when it is rotated to the detection position 24-view_P of the twenty-four view point. Subsequently, the optical property analyzer 330 may extract a correction coefficient for each view point from a memory or a register in the manner described above with reference to FIGS. 12 and 13.

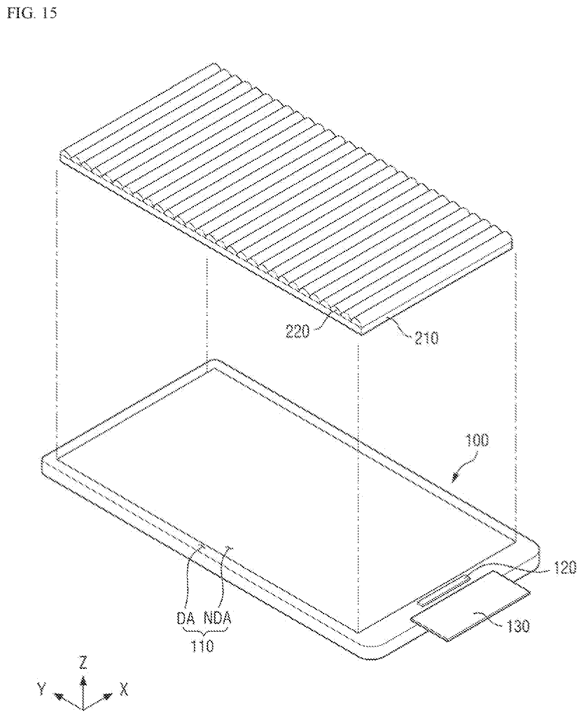

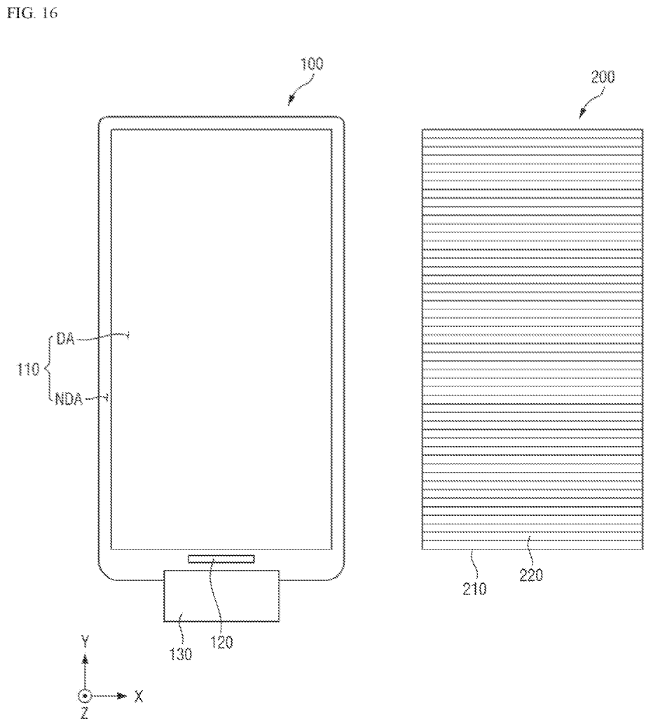

FIG. 15 is an exploded, perspective view of a display device according to an embodiment of the present disclosure. FIG. 16 is a plan view showing the display panel and the optical member shown in FIG. 15.

Referring to FIGS. 15 and 16, a display device according to an embodiment may be implemented as a flat-panel display device such as an organic light-emitting display (OLED), and may be a 3D display including the display module 100 and the optical member 200.

In an embodiment, the display module 100 may include a display panel 110, a display driver 120, and a circuit board 130.

The display panel 110 may include a display area DA and a non-display area NDA. The display area DA may include data lines, scan lines, supply voltage lines, and a plurality of pixels connected to the data lines and scan lines.

The optical member 200 may be disposed on the display module 100 (e.g., in the Z direction). The optical member 200 may be attached to one surface (e.g., a front surface, such as an upper surface in the Z direction) of the display module 100 through an adhesive member. The optical member 200 may be attached to the display module 100 by a panel bonding apparatus. For example, the optical member 200 may be implemented as a lenticular lens sheet including a plurality of stereoscopic lenses, such as first and second stereoscopic lenses LS1 to LS2.

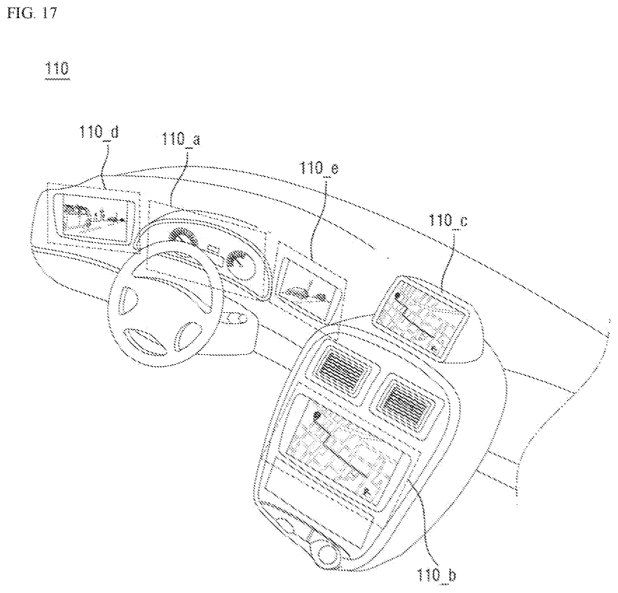

FIG. 17 is a perspective view showing an example of an instrument cluster and a center fascia including display devices according to an embodiment.

Referring to FIG. 17, the display device according to an embodiment in which the display module 100 and the optical member 200 are attached together may be applied to the instrument cluster 110_a of a vehicle, the center fascia 110_b of a vehicle, or a center information display (CID) 110_c disposed on the dashboard of a vehicle. In addition, the display device according to an embodiment may be applied to room mirror displays 110_d and 110_e, which can replace side mirrors of a vehicle, a navigation device, etc.

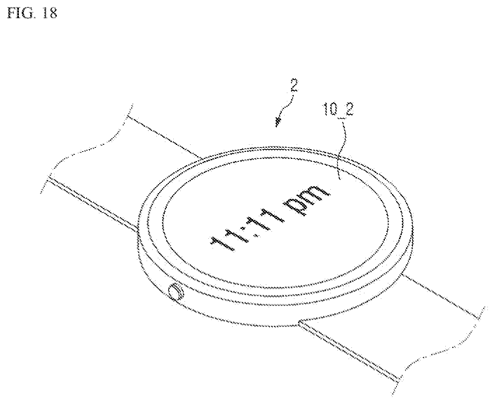

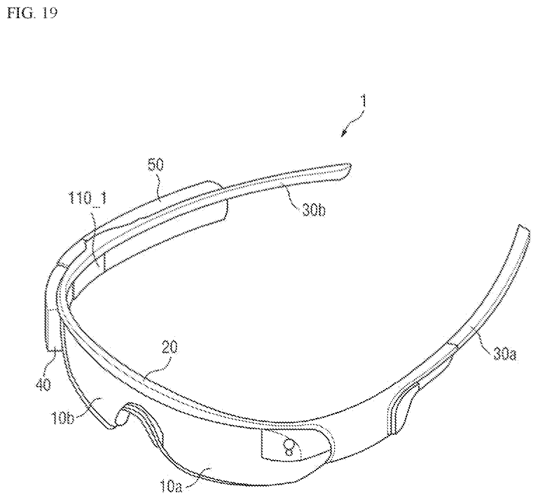

FIG. 18 is a perspective view showing an example of a watch-type smart device including a display device according to an embodiment of the present disclosure. FIG. 19 is a view showing an example of a glasses-type virtual reality device including a display device according to an embodiment.

FIG. 19 shows an example of a glasses-type virtual reality device 1 including temples 30a and 30b. The glasses-type virtual reality device 1 according to an embodiment shown in FIG. 19 may include the display device 110_1, a left eye lens 10a, a right eye lens 10b, a support frame 20, eyeglass temples 30a and 30b, a reflective member 40, and a display case 50.

The glasses-type virtual reality device 1 according to an embodiment may be applied to a head-mounted display including a band that can be worn on the head instead of the temples 30a and 30b. For example, the glasses-type virtual reality device 1 is not necessarily limited to that shown in FIG. 19 but may be applied to a variety of electronic devices in a variety of forms.

The display case 50 may include the display device 110_1 such as a micro-LED display device and the reflective member 40. An image displayed on the display device 110_1 may be reflected by the reflective member 40 and provided to the user's right eye through the right eye lens 10b. Accordingly, the user may watch a virtual reality image displayed on the display device through the right eye.

Although the display case 50 is disposed at the right end of the support frame 20 in an embodiment shown in FIG. 19, embodiments of the present disclosure are not necessarily limited thereto. For example, in an embodiment the display case 50 may be disposed at the left end of the support frame 20. In such embodiment, an image displayed on the display device 10_1 is reflected by the reflective member 40 and provided to the user's left eye through the left eye lens 10a. Accordingly, the user may watch a virtual reality image displayed on the display device 10_1 through the left eye. Alternatively, the display cases 50 may be disposed at both the left and right ends of the support frame 20, respectively. In such embodiment, the user can watch a virtual reality image displayed on the display device 10_1 through both the left and right eyes.

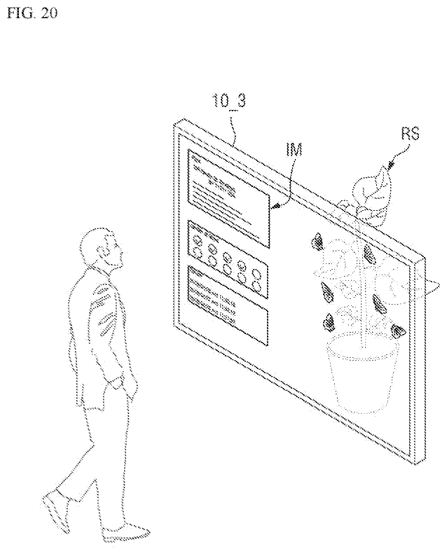

FIG. 20 is a perspective view showing an example of a transparent display apparatus including a transparent display device according to an embodiment.

Referring to FIG. 20, a display device in which the display module 100 and the optical member 200 are attached together may be applied to a transparent display apparatus. The transparent display device may transmit light while displaying images IM. Therefore, a user located on the front side of the transparent display device may not only watch the images IM displayed on the display module 100 but also watch an object RS or the background located on the rear side of the transparent display device. When an embodiment in which the display device in which the display module 100 and the optical member 200 are attached together is applied to the transparent display device, the display panel 110 of the display device may include a light-transmitting portion that can transmit light or may be made of a material that can transmit light.

In concluding the detailed description, those skilled in the art will appreciate that many variations and modifications can be made to the described embodiments without substantially departing from the principles of the present disclosure. Therefore, the described embodiments of the disclosure are used in a generic and descriptive sense only and not for purposes of limitation.

What is claimed is:

1. A display device comprising:
a display panel comprising a plurality of sub-pixels;
an optical member attached to the display panel, the optical member including stereoscopic lenses; and
a display driver receiving a correction coefficient for each view point of the display panel from a test apparatus for the display panel, the display driver correcting image data for each view point using the correction coefficient for each view point and driving the display panel so that an image associated with the corrected image data is displayed in a display area.

2. The display device of claim 1, wherein the display driver designates a view point and a view point number to each of the plurality of sub-pixels based on relative positions of the plurality of sub-pixels for each stereoscopic lens of the stereoscopic lenses of the optical member, aligns positions of the image data in horizontal lines according to the view point and the view point number of each of the plurality of sub-pixels, and corrects the image data for each view point with the correction coefficient for each view point to display the image associated with the corrected image data in the display area.

3. The display device of claim 2, wherein the test apparatus comprises:
an optical property detector detecting optical properties of a display image for each view point of the display panel and generating and outputting an optical property detection signal;
a detection position adjuster moving an optical detection position of the optical property detector to a predetermined detection position for each view point of the display panel; and
an optical property analyzer analyzing the optical property detection signal for each view point output from the optical property detector and generating and outputting the correction coefficient for each view point according to the detected optical properties for each view point.

4. The display device of claim 3, wherein:
view points and view point numbers of the display panel are in line with widths of the stereoscopic lenses in a thickness direction, respectively; and
numbers of the view points and view point numbers are equal to a number of the plurality of sub-pixels disposed on a rear side of each of the stereoscopic lenses.

5. The display device of claim 3, wherein:
the detection position adjuster sequentially moves the optical property detector to the predetermined detection position for each view point;
the optical property detector detects one of optical properties selected from luminance, illuminance and amount of light of the display image displayed on the display panel for each view point and transmits the optical property detection signal corresponding to the one of the optical properties selected from luminance, illuminance and amount of light to the optical property analyzer.

6. The display device of claim 5, wherein the optical property detector comprises:
at least one integrating sphere; and
at least one optical property detection sensor disposed inside the at least one integrating sphere.

7. The display device of claim 3, wherein the detection position adjuster moves the optical property detector along a curved track in a circular, elliptical or semi-circular shape with respect to a center point of the display panel, wherein a distance between the center point of the display panel and the optical property detector is maintained along the curved track.

8. The display device of claim 3, wherein:
the optical property analyzer converts the optical property detection signal for each view point into a digital signal and calculates the correction coefficient for each view point of the display panel by comparing and analyzing optical property values for different view points in the converted optical property detection signal with a predetermined calculation formula.

9. The display device of claim 8, wherein:
the optical property analyzer analyzes for each view point an average or a sum of optical property values of remaining view points designated by the display driver relative to an optical property value of each view point; and
the optical property analyzer compares the optical property value for each view point with the average or sum of the optical property values of the remaining view points designated by the display driver and calculates the correction coefficient for each view point, wherein the correction coefficient is calculated so that a difference value between the optical property value for each view point and the average or sum of the optical property values of the remaining view points is minimized.

10. A test system comprising:
a display device for displaying a stereoscopic image through a display panel having an optical member attached thereto; and
a test apparatus for detecting optical properties of a display image for each view point of the display panel, the test apparatus generating and outputting to the display device a correction coefficient for each view point according to the detected optical properties for each view point,
wherein the test apparatus generates optical property detection signals according to the detected optical properties of the display image for different view points of the display panel, and calculates the correction coefficient for each view point according to analysis results of the optical property detection signals for the view points.

11. The test system of claim 10, wherein the display device further comprises:
a display driver receiving the correction coefficient for each view point of the display panel from the test apparatus, the display driver correcting image data for each view point using the correction coefficient for each view point and driving the display panel to display an image associated with the corrected image data in a display area.

12. The test system of claim 10, wherein the test apparatus comprises:
an optical property detector detecting optical properties of a display image for each view point of the display panel and generating and outputting the optical property detection signal;
a detection position adjuster moving an optical detection position of the optical property detector to a predetermined detection position for each view point of the display panel; and
an optical property analyzer analyzing the optical property detection signal for each view point output from the optical property detector and generating and outputting the correction coefficient for each view point according to the detected optical properties for each view point.

13. The test system of claim 12, wherein:
the detection position adjuster sequentially moves the optical property detector to the predetermined detection position for each view point; and
the optical property detector detects one of optical properties selected from luminance, illuminance and amount of light of the display image displayed on the display panel for each view point and transmits the optical property detection signal corresponding to the one of the optical properties selected from the luminance, illuminance and amount of light to the optical property analyzer.

14. The test system of claim 12, wherein the detection position adjuster moves the optical property detector along a curved track in a circular, elliptical or semi-circular shape with respect to a center point of the display panel, wherein a distance between the center point of the display panel and the optical property detector is maintained along the curved track.

15. The test system of claim 12, wherein:
the optical property analyzer converts the optical property detection signal for each view point into a digital signal and calculates the correction coefficient for each view point of the display panel by comparing and analyzing optical property values for different view points in the converted optical property detection signal with a predetermined calculation formula.

16. The test system of claim 15, wherein:
the optical property analyzer analyzes for each view point an average or a sum of optical property values of remaining view points relative to an optical property value of each view point; and
wherein the optical property analyzer compares the optical property value for each view point with the average or sum of the optical property values of the remaining view points and calculates the correction coefficient for each view point, wherein the correction coefficient is calculated so that a difference value between the optical property value for each view point and the average or sum of the optical property values of the remaining view points is minimized.

17. The test system of claim 15, wherein the optical property analyzer analyzes for each view point analysis results of a sum of optical property values of remaining view points relative to an optical property value of each view point; and
the optical property analyzer calculates the correction coefficient for each view point in inversely proportional to the analysis results from a memory or a register so that a difference value between the optical property value for each view point and the sum of the optical property values of the remaining view points is minimized.

18. The test system of claim 17, wherein the correction coefficient for each view point is set in inverse proportion to the difference value between the optical property value for each view point and the sum of optical property values of the remaining view points and stored in a memory or a register in advance.

19. The test system of claim 15, wherein the optical property analyzer analyzes analysis results of an average of optical property values of remaining view points relative to an optical property value of each view point,
wherein the optical property analyzer calculates the correction coefficient for each view point in inverse proportion to the analysis results from a memory or a register, wherein the calculation of the correction coefficient minimizes a difference value between the optical property value for each view point and the average of the optical property values of the remaining view points.

20. The test system of claim 19, wherein the correction coefficient for each view point is set in inverse proportion to the difference value between the optical property value for each view point and the average of optical property values of the remaining view points and stored in a memory or a register in advance.
